(19) United States
(12) Patent Application Publication
(10) Pub. No.: US 2015/0166830 A1
(43) Pub. Date: Jun. 18, 2015

(54) REINFORCING FIBERS AND THEIR USE FOR CONCRETE REINFORCEMENT

(71) Applicants: Gerard Tardy, Sonnaz (FR); Daniel Gil, Jacob-Bellecombette (FR); Julie Mazzi, Venissieux (FR); Leticia Antepazo, Alcala De Henares (ES); Mariano Rico Martinez, Alcala De Henares (ES); Jese Antonio Foncubierta Arias, Meco (ES)

(72) Inventors: Gerard Tardy, Sonnaz (FR); Daniel Gil, Jacob-Bellecombette (FR); Julie Mazzi, Venissieux (FR); Leticia Antepazo, Alcala De Henares (ES); Mariano Rico Martinez, Alcala De Henares (ES); Jese Antonio Foncubierta Arias, Meco (ES)

(73) Assignee: OCV Intellectual Capital, LLC, Toledo, OH (US)

(21) Appl. No.: 14/345,008

(22) PCT Filed: Sep. 23, 2011
(86) PCT No.: PCT/IB11/02624

§ 371 Date: Oct. 9, 2014

(51) Int. Cl. C09D 175/08; C08K 7/14

(52) U.S. Cl. CPC C09D 175/08; C08K 7/14

(57) ABSTRACT

The present invention relates to, a sizing composition for reinforcing glass fiber strands, which comprises a silane coupling agent, a polyurethane film-forming agent including a blocked isocyanate and water. The invention also relates to glass fiber strands onto which the sizing composition has been applied, and to concrete reinforced with said glass fiber strands.

### RELATED APPLICATIONS

This application is the U.S. national phase entry of PCT/IB2011/002624 with an international filing date of Sep. 23, 2011, the priority to and any other benefit of which is hereby claimed and the disclosure of which is incorporated herein by reference in its entirety.

### FIELD OF THE INVENTION

The present invention relates generally to a sizing composition for reinforcing fiber materials, and more particularly, to a chemical composition for chopped reinforcement fibers used to reinforce concrete.

### BACKGROUND OF THE INVENTION

Glass fibers are useful in a variety of technologies. For example, glass fibers are commonly used as reinforcements in polymer matrices to form glass fiber reinforced plastics or composites. Glass fibers have been used in the form of continuous or chopped filaments, strands, rovings, woven fabrics, nonwoven fabrics, chopped and continuous filaments, mats, meshes, and scrims to reinforce polymers.

Chopped glass fibers are commonly used as reinforcement materials in composites. Conventionally, glass fibers are formed by attenuating streams of a molten glass material from a bushing or orifice. An aqueous sizing composition, or chemical treatment, is typically applied to the glass fibers after they are drawn from the bushing. An aqueous sizing composition commonly containing lubricants, coupling agents and film-forming binder resins is applied to the fibers. The sizing composition provides protection to the fibers from interfilament abrasion, ensures good cohesion between filaments and promotes compatibility between the glass fibers and the matrix in which the glass fibers are to be used. A sizing composition used to reinforce thermoset resins is described in WO 2008/085304.

Glass fibers can also be used as reinforcements in concrete, as described in JP-A-2002068810, JP-A-2002154853, JP-A-2003246655 and JP-A-2003335559. In these patent applications, the emphasis is on the glass composition, which has to be alkaline-resistant to resist the high pH environment in concrete. Concrete reinforced with non-alkaline resistant glass fibers is described in U.S. Pat. No. 6,582,511; such concrete is said to have improved plastic shrinkage crack resistance only.

### SUMMARY OF THE INVENTION

The aim of the present invention is to provide glass fibers that exhibit high cohesion and abrasion resistance, as well as good durability in a cement matrix over time.

It is therefore an object of the present invention to provide a reinforcing glass fiber strand that is formed of a plurality of individual glass fibers coated with a sizing composition comprising at least one silane coupling agent, a polyurethane film-forming agent including a blocked isocyanate, and water.

Examples of polyurethane film-forming agents including a blocked isocyanate that may be used in the sizing composition include polyester-based polyurethane film-forming agents including a blocked isocyanate and polyether-based polyurethane film-forming agents including a blocked isocyanate.

The polyurethane film-forming agent including a blocked isocyanate may be in the form of an aqueous dispersion, emulsion, and/or solution.

The isocyanate of the polyurethane film-forming agent preferably de-blocks at a temperature that permits simultaneous or nearly simultaneous de-blocking and curing of said polyurethane film forming agent. In one embodiment, the blocked isocyanate de-blocks at a temperature between about 107.2° C. (225° F.) and about 176.7° C. (350° F.), preferably at a temperature between about 125° C. (250° F.) and about 165.6° C. (330° F.).

Examples of silane coupling agents that may be used in the sizing composition include aminosilanes, silane esters, vinyl silanes, methacryloxy silanes, epoxy silanes, sulfur silanes, ureido silanes, isocyanato silanes, and mixtures thereof. In one embodiment, a single silane coupling agent, or a mixture of two or three silane coupling agents, is used.

The polyurethane film-forming agent that includes a blocked isocyanate may be present in the sizing formulation in an amount from about 25% to about 75% by weight (dry solids content) of the total solid composition and the silane coupling agent(s) may be present in the sizing composition in an amount from about 2% to about 15% by weight (dry solids content) of the total solid composition.

It is another object of the present invention to provide reinforced concrete comprising concrete and glass fiber strands as defined above.

The glass fiber strands may be present in the concrete in an amount from about 0.02% to about 3% by volume of the concrete, preferably from about 0.05% to about 2% by volume of the concrete.

The glass fiber strands preferably have a length from about 0.64 to about 5.08 cm (about 0.25 to about 2.5 inches), more preferably from about 1.2 cm to about 4.5 cm and a filament diameter from about 13 to about 23 μm. The glass fiber strands have a mass linear density from about 50 to about 600 tex, preferably from about 130 to about 500 tex.

In one embodiment, the glass fiber strands are in the form of chopped strands. It is yet another object of the present invention to provide a method of forming reinforced glass fiber strands which comprises the steps of applying a sizing composition to a plurality of attenuated glass fibers, gathering the glass fibers into glass fiber strands that have a predetermined number of glass fibers therein, chopping the glass fiber strands to form wet chopped glass fiber bundles, and drying the wet chopped glass fiber bundles in a drying oven to form chopped glass fiber bundles.

It is an advantage of the present invention that the glass fibers exhibit a better abrasion resistance during the mixing stage in fresh concrete, so the fibers can retain their physical properties. It is an advantage of the fibers manufactured according to the present invention not to disturb or decrease the workability of the fresh concrete. In addition to this, these fibers generate a strong reinforcement of the hardened concrete with the capacity of acting and creating ductility during the post-crack stage. These fibers also present a long-term durability in cement matrix thanks to the high chemical resistance of the crosslinked polyurethane polymer created at the surface of the glass fiber.

The foregoing and other objects, features, and advantages of the invention will appear more fully hereinafter from a consideration of the detailed description that follows and the accompanying drawings.

### BRIEF DESCRIPTION OF THE DRAWINGS

FIG. 1 is a flow diagram illustrating steps of an exemplary process for forming glass fiber bundles according to at least one exemplary embodiment of the present invention.

FIG. 2 is a schematic illustration of a processing line for forming dried chopped strand bundles according to at least one exemplary embodiment of the present invention.

FIG. 3 is a schematic illustration of a chopped strand bundle according to an exemplary embodiment of the present invention.

### DETAILED DESCRIPTION AND PREFERRED EMBODIMENTS OF THE INVENTION

The present invention relates to a reinforcing glass fiber strand that is formed of a plurality of individual reinforcing glass fibers coated with a sizing composition. The sizing composition comprises at least one silane coupling agent, a polyurethane film-forming agent that includes a blocked isocyanate, and water. The blocked isocyanate utilized in the polyurethane film-forming agent preferably deblocks at a temperature that permits simultaneous or nearly simultaneous de-blocking and curing of said polyurethane film-forming agent. Glass fibers sized with the sizing composition can be chopped and dried in-line to form chopped glass fiber bundles. Chopping the glass fibers in-line lowers the manufacturing costs for the products produced from the sized glass fibers and avoids the intermediate step of winding cakes, drying and chopping off line. The sizing composition may be applied to the glass fibers by any conventional method, including kiss roll, dip-draw, slide, or spray application to achieve the desired amount of the sizing composition on the fibers. Any type of glass, such as A-type glass, C-type glass, E-type glass, S-type glass, E-CR-type glass (for example, Advantex® glass fibers commercially available from Owens Corning), boron-free glass, wool glass, alkaline resistant glass (for example, Cem-FIL® glass commercially available from Owens Corning) or combinations thereof may be used as the reinforcing fiber. Preferably, the reinforcing fiber is an alkaline resistant glass fiber. The sizing composition may be applied to the fibers with a Loss on Ignition (LOI) from about 0.8 to about 2.5 on the dried fiber, preferably from about 1.4 to about 2.2, more preferably from about 1.6 to about 2.2. As used in conjunction with this application, LOI may be defined as the percentage of organic solid matter deposited on the glass fiber surfaces. Alternatively, the glass fiber can be used in combination with strands of one or more synthetic polymers such as, but not limited to, polyester, polyamide, aramid, polyaramid, polypropylene, polyethylene, polyvinyl alcohol and mixtures thereof.

As discussed above, the sizing composition contains at least one silane coupling agent. Silanes function inter alia to reduce the level of fuzz, or broken fiber filaments, during subsequent processing. When needed, a weak acid such as acetic acid, boric acid, metaboric acid, succinic acid, citric acid, formic acid, and/or polyacrylic acid may be added to the sizing composition to assist in the hydrolysis of the silane coupling agent. Examples of silane coupling agents that may be used in the sizing composition may be characterized by the functional groups amino, epoxy, vinyl, methacryloxy, ureido, isocyanato, and azamido. In preferred embodiments, the silane coupling agents include silanes containing one or more nitrogen atoms that have one or more functional groups such as amine (primary, secondary, tertiary, and quarternary), amino, imino, amido, imido, ureido, isocyanato, or azamido.

Non-limiting examples of suitable silane coupling agents include aminosilanes, silane esters, vinyl silanes, methacryloxy silanes, epoxy silanes, sulfur silanes, ureido silanes, and isocyanato silanes. Specific examples of silane coupling agents for use in the instant invention include [gamma]-aminopropyltriethoxysilane (A-1100), n-phenyl-[gamma]-aminopropyltrimethoxysilane (Y-9669), n-trimethoxy-silyl-propyl-ethylene-diamine (A-1120), methyltrichlorosilane (A-154), [gamma]-chloropropyl-trimethoxy-silane (A-143), vinyl-triacetoxysilane (A-188), methyltrimethoxysilane (A-1630), [gamma]-ureidopropyltrimethoxysilane (A-1524). Other examples of suitable silane coupling agents are set forth in Table 1. All of the silane coupling agents identified above and in Table 1 are available commercially from GE Silicones. Preferably, the silane coupling agent is an aminosilane or a diaminosilane.

TABLE 1

| Silanes | Label |
|---|---|
| Vinyl silanes | |
| Vinyltriethoxysilane | A-151 |
| Vinyltrimethoxysilane | A-171 |
| Vinyl-tris-(2-methoxyethoxy)silane | A-172 |
| Methacryloxy silanes | |
| γ-methacryloxypropyltriethoxysilane | A-174 |
| Epoxy silanes | |
| (3,4-epoxycyclohexyl)ethyl- | A-186 |
| trimethoxysilane | |
| Amino silanes | |
| γ-aminopropyltriethoxysilane | A-1101 |
| | A-1102 |
| Aminoalkyl silicone | A-1106 |
| γ-aminopropyltrimethoxysilane | A-1110 |
| Triaminofunctional silane | A-1130 |
| Bis-(γ-trimethoxysilylpropyl)amine | A-1170 |
| Polyazamide silylated silane | A-1387 |
| Ureido silanes | |
| γ-ureidopropyltrialkoxysilane | A-1160 |
| γ-ureidopropyltrimethoxysilane | Y-11542 |

The sizing composition may include one or more coupling agents. The coupling agent(s) may be present in the sizing composition in an amount from about 2% to about 15% by weight (dry solids content) of the total solid composition, preferably in an amount from about 5% to about 15% by weight (dry solids content), more preferably in amount from about 10% to about 15% by weight (dry solids content) of the total solid composition.

As discussed above, the sizing composition comprises a polyurethane film-forming agent. Film-forming agents create improved adhesion between the reinforcing fibers, which results in improved strand integrity. In the sizing composition, the film-forming agent acts as a polymeric binding agent to provide additional protection to the reinforcing fibers and to improve processability, such as to reduce fuzz that may be generated by high speed chopping.

The polyurethane film-forming agent used in the sizing formulation of the present invention includes a blocked isocyanate. Preferred film-forming agents for use in the sizing composition include polyester-based and polyether-based polyurethanes that include a blocked isocyanate. As used herein, the term “blocked” is meant to indicate that the isocyanate groups have been reversibly reacted with a compound so that the resultant blocked isocyanate group is stable to active hydrogens at ambient temperature but reactive with active hydrogens in the film-forming polyurethane at elevated temperatures, such as, for example, at temperatures between about 93.33° C. (200° F.) and about 204.4° C. (400° F.).

The isocyanate utilized in the sizing composition can be fully blocked or partially blocked so that it will not react with the active hydrogens of the other components until the strands of chemically treated (that is, sized) glass fibers are heated to a temperature sufficient to unblock the blocked isocyanate and cure the film-forming agent. In the sizing composition used in the invention, the isocyanate preferably de-blocks at a temperature between about 107.2° C. (225° F.) and about 176.7° C. (350° F.), and more preferably at a temperature between about 125° C. (250° F.) and about 165.6° C. (330° F.). Groups suitable for use as the blocker or blocking portion of the blocked isocyanate are well-known in the art and include groups such as alcohols, lactams, oximes, malonic esters, alkyl acetoacetates, triazoles, phenols, amines, and benzyl t-butylamine (BBA). One or several different blocking groups may be used.

Non exhaustive examples of water dispersion of blocked isocyanate include Baybond PU 403, Baybond PU RSC 825, Baybond 406, Baybond PU130 from (Bayer), Witcobond 60X (Witco), Baxenden 199-76X, Trixene DP/9B1961, Stantex EC 1159 PRO (from Pulcra),

The polyurethane film-forming agent including a blocked isocyanate may be present in the sizing composition in an amount from about 25% to about 75% by weight (dry solids content) of the total solid composition, preferably in an amount from about 30% to about 70% by weight (dry solids content), more preferably in an amount from about 35% to about 70% by weight (dry solids content). Said film-forming agent may be added in the form of an aqueous dispersion, emulsion, or solution.

The sizing composition further comprises water to dissolve or disperse the active solids for application onto the glass fibers. Water may be added in an amount sufficient to dilute the aqueous sizing composition to a viscosity that is suitable for its application to glass fibers and to achieve the desired solids content on the fibers. In particular, the sizing composition may contain up to about 90% by weight water.

In addition to the isocyanate blocked polyurethane, the sizing composition may include a polymer-based secondary film former such as an epoxy, polyester, polyvinyl acetate, acrylics, non reactive polyurethane, functionalized polyolefins or mixtures thereof in an amount of about 5% to about 60% by weight (dry solids content) of the total solid composition. Non exhaustive examples of aqueous dispersion of such polymers include: Neoxil 1143, Neoxil 9158 (available from DSM), Epirez 5520 (available from Hexion), Witcobond 290H (available from Chemtura), Airflex EP 740 (available from Wacker), Filco 310 (available from COIM), Vinamul 8828, Vinamul 8852, Impranil DLS (Bayer).

In some embodiments, the sizing composition may optionally comprise at least one lubricant to facilitate fiber manufacturing and composite processing and fabrication. In embodiments where a lubricant is utilized, the lubricant may be present in the sizing composition in an amount from about 0.1% to about 5% by weight (dry solids content) of the total solid composition. Although any suitable lubricant may be used, examples of lubricants for use in the sizing composition include, but are not limited to, water-soluble ethyleneglycol stearates (for example, polyethyleneglycol monostearate, butoxyethyl stearate, polyethylene glycol monooleate, and butoxyethylstearate), ethyleneglycol oleates, ethoxylated fatty amines, glycerin, emulsified mineral oils, organopolysiloxane emulsions, carboxylated waxes, linear or (hyper)branched waxes or polyolefins with functional or non-functional chemical groups, or modified waxes and polyolefins, nanoclays, nanoparticles, and nanomolecules. Specific examples of lubricants suitable for use in the size composition include stearic ethanolamide, sold under the trade designation Lubesize K-12 (available from AOC); PEG 400 MO, a monooleate ester having 400 ethylene oxide groups (available from Cognis); Emery 6760 L, a polyethyleneimine polyamide salt (available from Cognis); Lutensol ON60 (available from BASF); Radiacid (a stearic acid available from Fina); Michemlub 723 (from Michelman) and Astor HP 3040 and Astor HP 8114 (microcrystalline waxes available from IGI International Waxes, Inc).

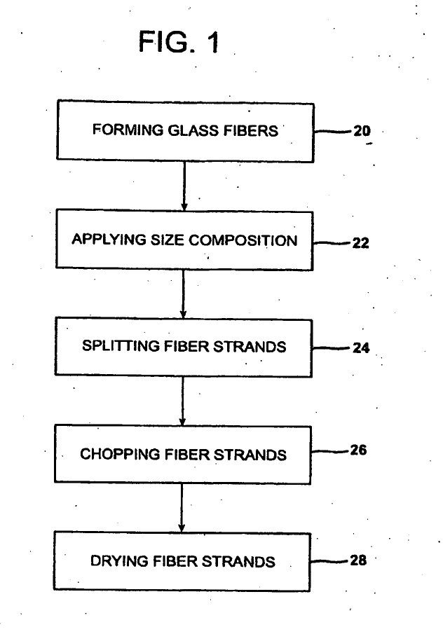

Additives such as pH adjusters, processing aids, antifoaming agents, antistatic agents, thickening agents, adhesion promoters, compatibilizers, stabilizers, impact modifiers, pigments, dyes, colorants and/or fragrances may be added in small quantities to the sizing composition in some embodiments. The total amount of additives that may be present in the sizing composition may be from 0 to about 5.0% by weight (dry solids content) of the total solid composition, and in some embodiments, the additives may be added in an amount from about 0.2% to about 5.0% by weight (dry solids content) of the total solid composition. In the embodiment described generally in FIG. 1, a process of forming chopped glass fiber strands in accordance with one aspect of the invention is depicted. In particular, the process includes forming glass fibers (Step 20), applying the sizing composition to glass fibers (Step 22), splitting the fibers to obtain fiber strands (Step 24), chopping the fiber strands to a discrete length (Step 26), and drying the fiber strands (Step 28) to form chopped glass fiber bundles.

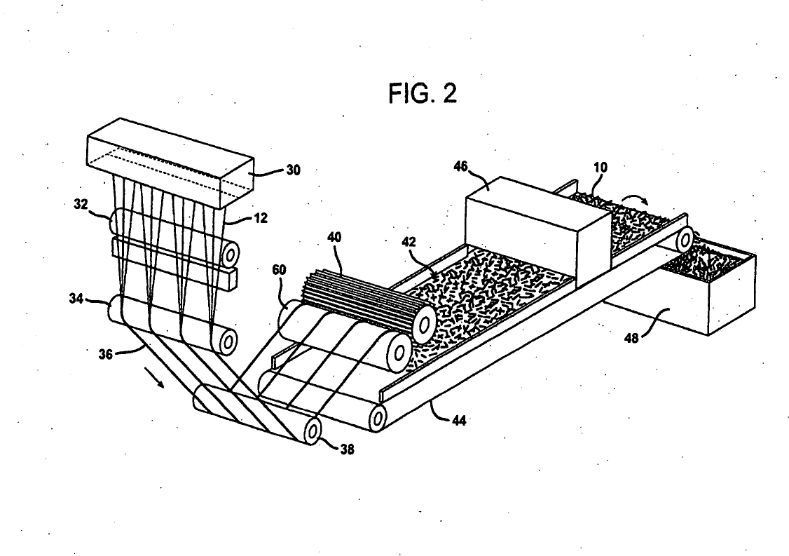

As shown in more detail in FIG. 2, glass fibers 12 may be formed by attenuating streams of a molten glass material (not shown) from a bushing or orifice 30. The sizing composition is applied to the fibers in an amount sufficient to provide the fibers with a moisture content from about 6% to about 12%. The attenuated glass fibers 12 may have a diameter from about 12 microns to about 24 microns. Preferably, the fibers 12 have a diameter from about 14 microns to about 20 microns.

After the glass fibers 12 are drawn from the bushing 30, the aqueous sizing composition is applied to the fibers 12. The sizing composition may be applied by conventional methods such as by the application roller 32. Once the glass fibers 12 are treated with the sizing composition, they are gathered and split into fiber strands 36 having a specific, desired number of individual glass fibers 12.

The splitter shoe 34 splits the attenuated, sized glass fibers 12 into fiber strands 36. The glass fiber strands 36 may optionally be passed through a second splitter shoe (not shown) prior to chopping the fiber strands 36. The specific number of individual glass fibers 12 present in the fiber strands 36 (and therefore the number of splits of the glass fibers 12) will vary depending on the particular application for the chopped glass fiber bundles 10, and is easily determined by one of ordinary skill in the art. In the present invention, it is preferred that each reinforcing fiber strand or bundle contains from 100 fibers to 2500 fibers or more.

The fiber strands 36 are then passed from the gathering shoe 38 to a chopper 40/cot 60 combination where they are chopped into wet chopped glass fiber bundles 42. The strands 36 may be chopped to have a length from about 1.28 cm (0.5 inch) to about 5.08 cm (2 inches). The wet, chopped glass fiber bundles 42 may fall onto a conveyor 44 (such as a foraminous conveyor) for conveyance to a drying oven 46. The bundles of wet, sized chopped fibers 42 are then dried to consolidate or solidify the sizing composition on the glass fibers 12. Preferably, the wet fiber bundles 42 are dried in an oven 46 such as a fluidized-bed oven (that is, a Cratec® oven (available from Owens Corning)), a rotating thermal tray oven, or a dielectric oven to form the dried, chopped glass fiber bundles 10. In one embodiment, the fibers are heat-treated for about 15 minutes to about 90 minutes at a temperature between about 140° C. and about 170° C.

The dried fibers may then be passed over screens (not shown) to remove longs, fuzz balls, and other undesirable matter before the chopped glass fibers are collected. In one embodiment, greater than (or equal to) 99% of the free water (that is, water that is external to the chopped fiber bundles) is removed. It is desirable, however, that substantially all of the water is removed by the drying oven 46. The phrase “substantially all of the water,” as used herein, is meant to denote that all or nearly all of the free water from the fiber bundles is removed. In a preferred embodiment, the wet, chopped fiber bundles 42 are pre-dried on conveyor 44 before being dried in the oven 46. This can be done, for example, by blowing a warm air flow through a carpet or inside a tunnel (not shown). The pre-drying treatment has the effect of partially reducing the moisture of the wet chopped fiber bundles to prevent caking, clogging and adhesion between strands that may occur during the drying treatment. When the wet chopped fibers are pre-dried, this is preferably carried out for a few seconds at a temperature from about 60° C. to about 130° C.

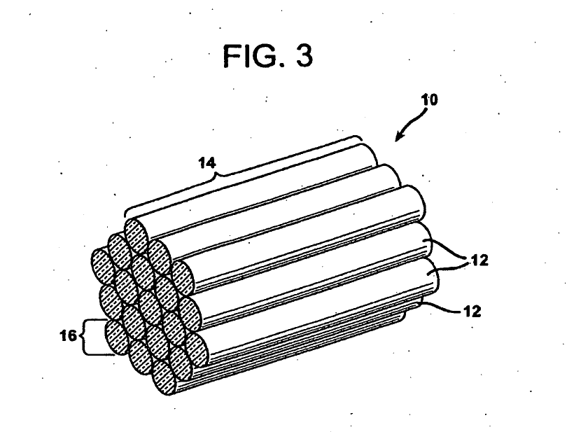

An example of a chopped glass fiber bundle 10 according to the present invention is depicted generally in FIG. 3. As shown in FIG. 3, the chopped glass fiber bundle 10 is formed of a plurality of individual glass fibers 12 having a diameter 16 and a length 14. The individual glass fibers 12 are positioned in a substantially parallel orientation to each other in a tight knit or “bundled” formation. As used herein, the phrase “substantially parallel” is meant to denote that the individual glass fibers 12 are parallel or nearly parallel to each other.

The dried, sized, chopped reinforcement fiber bundles may be used to reinforce concrete. As used herein, the term “concrete” means the combination of cement, aggregate, sand, water and optionally additives commonly used in the field.

Having generally described this invention, a further understanding can be obtained by reference to certain specific examples illustrated below which are provided for purposes of illustration only and are not intended to be all inclusive or limiting unless otherwise specified.

### EXAMPLES

### 1) Sizing Preparation and Composition

The following examples were prepared by adding slowly the silane coupling agent solution to water and stirring for about 20 minutes to ensure a complete hydrolyzation of the material. Then, the other raw materials were diluted into water before being mixed together and with the silane coupling agent. The composition of examples 1-8 is given in Table 2 below.

The amounts indicated in the examples are expressed as % by weight (dry solids content) of the total solid composition.

TABLE 2

| | Ex. | Ex. | Ex. | Ex. | Ex. | Ex. | Ex. | Ex. |
|---|---|---|---|---|---|---|---|---|
| | 1 | 2 | 3 | 4 | 5 | 6 | 7 | 8 |
| Silquest A1100 | 13 | 10 | 7 | 9 | — | 7 | 10 | 12 |
| Silquest A1120 | — | — | — | — | — | 3 | — | — |
| Silquest A1170 | — | — | — | — | 7 | — | — | — |
| Baybond PU RSC 825 | 25 | 25 | 23 | 23 | 25 | 25 | — | — |
| Baybond PU 406 | 29 | 37 | 26 | 33 | 36 | 33 | — | — |
| Baybond PU 130 | — | — | — | — | — | — | 60 | 30 |
| Witcobond 290H | — | — | — | — | — | — | — | 30 |
| Neoxil 8294 | 32 | 25 | 43 | 34 | 32 | — | 28 | 28 |
| Filco 310 | — | — | — | — | — | 32 | — | — |
| PEG400 MO | 2 | 3 | — | 1 | — | — | — | — |
| Emery 6760L | 1 | — | 2 | — | — | — | — | — |
| Miclemlub 723 HS | — | — | — | — | — | — | 2 | — |

### 2) Glass Fiber Production

The sizing composition was roller applied directly on alkali-resistant glass fibers whereby reinforced glass fibers were obtained. The properties of the reinforced fibers are given in Table 3.

The sizing composition of examples 3a, 4a and 5a was identical to that of examples 3, 4 and 5, respectively, except that the total dry solid content of the size was changed in order to modify the LOI of the fibers.

### 3) Reinforcement of Concrete

Abrasion resistance is a qualitative comparison of the aspect of the reinforced glass fiber before and after mixing for 6 min with fresh mortar and aggregates (0 to 4 mm). A grade on a scale from 1 to 5 was awarded to the fibers; grade 5 indicates that the fiber is exactly in the same shape after and before mixing; grade 1 indicates that the fiber is completely opened or broken.

Concrete for casting specimen was prepared by mixing cement, sand (0 to 4 mm), aggregates (4 to 16 mm) and water. The ratio Water/Cement was 0.55 and the ratio between the different components led to a concrete belonging to the compression class C30 and to the flowability class S2. 0.5% by volume of reinforced fibers of the invention was added to the concrete thus obtained with mixing. Thanks to the good ability of the fibers to disperse in fresh concrete, an homogeneous dispersion was obtained after a mixing time of 2 to 3 minutes. The mechanical properties of concrete were evaluated in accordance with standard EN 14651 after 28 days. fR1, fR2 and fR3 are the respective strength in MPa for a Crack Mouth Opening Displacement (CMOD) of 0.5 mm, 1.5 mm and 2.5 mm respectively, calculated after testing the fibers of the invention in concrete.

The properties of the concrete are also given in Table 3.

TABLE 3

| | | | | Concrete | | | |
|---|---|---|---|---|---|---|---|
| Sizing | Reinforced fiber | | | | Crack mouth opening | | |
| compo- | | Length | Yardage | Abrasion | Resistance (MPa) | | |
| sition | LOI | (mm) | (tex) | resistance | fR1 | fR2 | fR3 |
| Ex. 1 | 1.98 | 24 | 320 | 2.5 | 2.15 | 1.22 | 0.3 |
| Ex. 2 | 2.05 | 36 | 480 | 4 | 2.46 | 1.67 | 1.15 |
| Ex. 3 | 1.75 | 36 | 480 | 1 | 1.52 | 0.57 | 0.17 |
| Ex. 3a | 2.12 | 36 | 480 | 2 | 1.75 | 0.85 | 0.23 |
| Ex. 4 | 2.01 | 36 | 480 | 4 | 2.79 | 1.86 | 1.19 |
| Ex. 4a | 1.55 | 36 | 480 | 2 | 2.35 | 1.28 | 0.55 |
| Ex. 5 | 1.81 | 24 | 480 | 4 | 2.57 | 1.38 | 0.35 |
| Ex. 5a | 1.98 | 36 | 480 | 4 | 2.52 | 1.68 | 1.17 |
| Ex. 6 | 1.80 | 36 | 480 | 3 | 2.73 | 1.48 | 0.87 |
| Ex. 7 | 2.12 | 36 | 480 | 4 | 2.61 | 1.73 | 1.14 |
| Ex. 8 | 2.05 | 36 | 480 | 3.5 | 2.35 | 1.53 | 1.06 |

It can be seen from Table 3 that fibers with a LOI between about 1.6 and 2.2 are obtained. The sizing compositions of the invention, which comprise the required amount of blocked isocyanate, are suitable to reinforce a concrete matrix as they display good abrasion resistance and crack mouth opening properties. It is in particular noted that fR1 values are quite high, and that fR3 values retain up to about 40% of the corresponding fR1 values.

1. A reinforcing glass fiber strand comprising a plurality of individual glass fibers coated with a sizing composition, said sizing composition comprising at least one silane coupling agent, a polyurethane film-forming agent including a blocked isocyanate, and water, wherein said polyurethane film-forming agent including a blocked isocyanate is present in said sizing composition in an amount from about 25% to about 75% by weight (dry solids content) of the total solid composition.

2. The reinforcing glass fiber strand of claim 1, wherein said polyurethane film-forming agent including a blocked isocyanate is selected from a polyester-based polyurethane film-forming agent including a blocked isocyanate and a polyether-based polyurethane film-forming agent including a blocked isocyanate.

3. The reinforcing glass fiber strand of claim 1,
wherein said polyurethane film-forming agent including a blocked isocyanate de-blocks at a temperature that permits simultaneous or nearly simultaneous de-blocking and curing of said polyurethane film-Twining agent.

4. The reinforcing glass fiber strand of claim 1, wherein said blocked isocyanate de-blocks at a temperature between 107.2° C. (225° F.) and 176.7° C. (350° F.).

5. The reinforcing glass fiber strand of claim 4, wherein said blocked isocyanate de-blocks at a temperature between 125° C. (250° F.) and 165.6° C. (330° F.).

6. The reinforcing glass fiber strand of claim 1, wherein said at least one silane coupling agent is selected from aminosilanes, silane esters, vinyl silanes, methacryloxy silanes, epoxy silanes, sulfur silanes, ureido silanes, isocyanato silanes, and mixtures thereof.

7. The reinforcing glass fiber strand of claim 1, wherein said at least one silane coupling agent is present in said sizing composition in an amount from about 2% to about 15% by weight (dry solids content) of the total solid composition.

8. The reinforcing glass fiber strand of claim 1, wherein the sizing composition further comprises another film-forming agent selected from an epoxy, a polyester, a polyvinyl acetate, acrylics, a non reactive polyurethane, a functionalized polyolefin, and mixtures thereof, in an amount from about 5% to about 60% by weight (dry solids content) of the total solid composition.

9. The reinforcing glass fiber strand of claim 1, wherein the sizing composition is applied to the fibers with a Loss on Ignition on the dried fibers from about 0.8 to about 2.5.

10. The reinforcing glass fiber strand of claim 1, wherein said glass fibers are alkaline resistant glass fibers.

11. A sizing composition comprising at least one silane coupling agent, a polyurethane film-forming agent including a blocked isocyanat; and water, wherein said polyurethane film-forming agent including a blocked isocyanate is present in said sizing composition in an amount from about 25% to about 75% by weight (dry solids content) of the total solid composition.

12. The sizing composition of claim 11, wherein the polyurethane film-forming agent including a blocked isocyanate is selected from a polyester-based polyurethane film-forming agent including a blocked isocyanate and a polyether-based polyurethane film-forming agent including a blocked isocyanate.

13. The sizing composition of claim 11, wherein
the said at least one silane coupling agent is selected from aminosilanes, silane esters, vinyl silanes, methacryloxy silanes, epoxy silanes, sulfur silanes, ureido silanes, isocyanato silanes, and mixtures thereof.

14. The sizing composition of claim 11, which further comprises another film-forming agent selected from an epoxy, a polyester, a polyvinyl acetate, acrylics, a non reactive polyurethane, a functionalized polyolefin, and mixtures thereof, in an amount from about 5% to about 60% by weight (dry solids content) of the total solid composition.

15. A reinforced concrete comprising concrete and glass fiber strands as defined in claim 1.

16. The reinforced concrete of claim 15, wherein the glass fiber strands are present in an amount from about 0.02% to about 3% by volume of the concrete.

17. The reinforced concrete of claim 15, wherein the glass fiber strands have a length from about 0.64 cm to about 5.08 cm and a diameter from about 12 μm to about 24 μm.

18. The reinforced concrete of claim 15, wherein the glass fiber strands are in the form of chopped strands.
